(19) United States
(12) Patent Application Publication
(10) Pub. No.: US 2011/0185841 A1
(43) Pub. Date: Aug. 4, 2011

(54) CABLE ADJUSTMENT DEVICE FOR BICYCLE REAR DERAILLEUR SYSTEM

(76) Inventor: CHI JUNG LI, Kaohsiung City (TW)

(21) Appl. No.: 12/700,594

(22) Filed: Feb. 4, 2010

(51) Int. Cl. F16C 1/22

(52) U.S. Cl. 74/502.2

(57) ABSTRACT

A cable adjustment device includes a rear derailleur system including a stationary member, a link, a movable member and a guide member. The stationary member has a passage which communicates with an interior space. A pivotal member is pivotably received in the interior space. An adjustment bolt extends through the passage and the pivotal member. The cable extends through the axial through hole in the adjustment bolt and is connected to the clamping member on the movable member. The interior space and the opening of the passage are wide enough so that the adjustment bolt can be pivoted about the axis of the pivotal member. The cable does not have any bending portion between the clamping member and the adjustment bolt.

### FIELD OF THE INVENTION

The present invention relates to an adjustment device, and more particularly, to an adjustment device for adjust tension of cable of bicycle rear derailleur system.

### BACKGROUND OF THE INVENTION

A conventional adjustment device for bicycle rear derailleur is shown in FIGS. 1 and 2, and generally includes an adjustment bolt 10 which is threadedly connected to the threaded hole 13 in the stationary member 12 of the rear derailleur system 11 and an end of the cable 14 extends through the adjustment bolt 10 and is fixed to the clamping member 16 of the link 15. By pulling or releasing the cable 14, the link 15 is movable relative to the stationary member 12 such that the link 15 moves the guide member 18 in lateral direction, and the chain engaged with the guide member 18 is shifted from one sprocket to another. The tension of the cable 14 can be adjusted by threading the adjustment bolt 10 within the threaded hole 13 such that the tension of the cable 14 can be kept at desired status to improve the looseness of the cable 14 after a period of operation.

However, the cable 14 extends through the adjustment bolt 10 and then is connected to the clamping member 16, so that the cable 14 bends an angle and this makes the cable 14 to move an extra distance when operation and causes delay when changing the chain between the sprockets. Besides, the angle of the cable 14 causes friction between the cable 14 and the adjustment bolt 10 and the friction shortens the lift of the cable 14.

The present invention intends to provide a cable adjustment device which allows the cable to be connected between the clamping member and the adjustment bolt without any bending and the adjustment bolt is pivotable when the cable is pulled or released to reduce the friction therebetween.

### SUMMARY OF THE INVENTION

The present invention relates to a cable adjustment device for a rear derailleur system which includes a stationary member, a link, a movble member and a guide member. The stationary member is connected to a bicycle seat stay and has an interior space defined therein. A passage is defined through the stationary member and communicates with the interior space. Two ends of the link are connected to the stationary member and the movable member respectively. The movable member is movable relative to the stationary member. The link has a clamping member and the guide member is connected to a side of the movable member. A pivotal member is pivotably received in the interior space and cannot separate from the passage. An adjustment bolt has a threaded section which extends through the passage and is connected to a threaded hole defined radially through the pivotal member. An outer diameter of the threaded section is smaller than an inner diameter of the passage. A through hole is defined axially through the adjustment bolt. A cable has an end extending through the through hole and is fixed to the clamping member.

The adjustment bolt can be pivoted within the interior space when the pivotal member is pivoted, so that when the cable is pulled or released, the cable can be always straight between the adjustment bolt and the clamping member. This allows the chain to be quickly shifted between the sprockets of the rear derailleur system without any bending.

The stationary member includes a side hole which communicates with the interior space, and the pivotal member is inserted into the interior space via the side hole.

The interior space may have a cylindrical inner wall or a spherical inner wall and the pivotal member is a cylindrical piece or a spherical piece which is pivotably engaged with the cylindrical inner wall or the spherical inner wall.

A recess is defined in an inner end of the interior space and the pivotal member includes a protrusion extending from an end thereof. The protrusion is rotatably engaged with the recess.

A plug is engaged with the side hole and restricts the pivotal member within the interior space.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional cable adjustment device connected with a bicycle rear derailleur system;

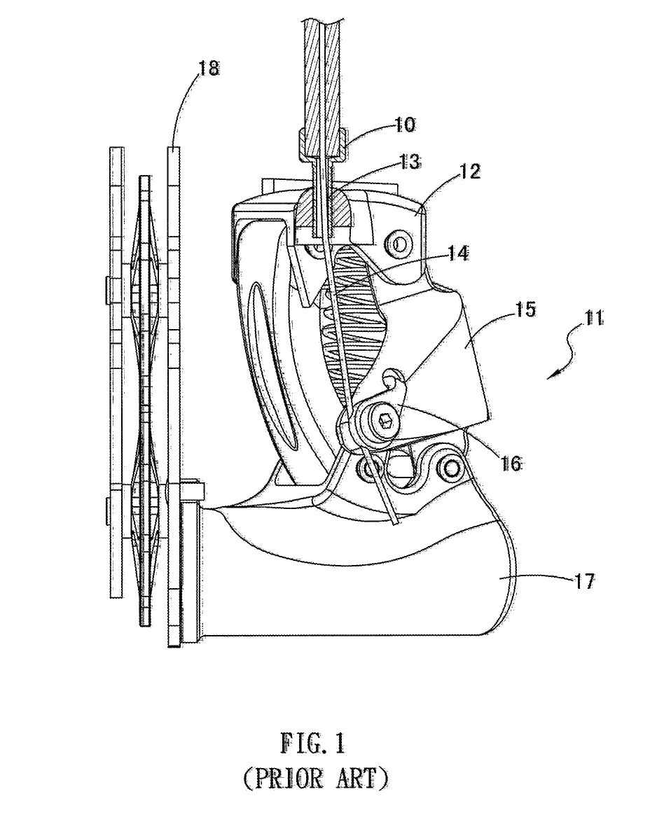

FIG. 2 shows that the cable of the conventional cable adjustment device is pulled;

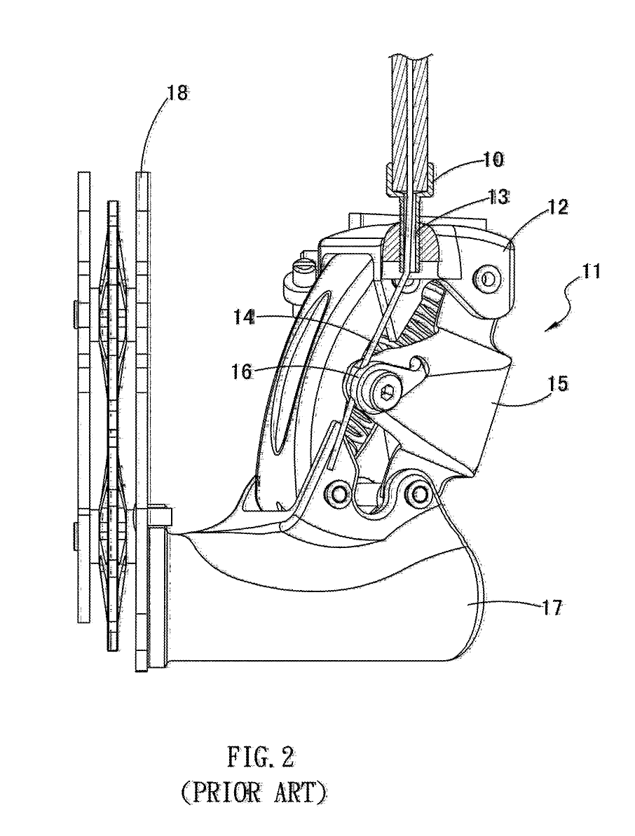

FIG. 3 shows the cable adjustment device of the present invention connected with a bicycle rear derailleur system;

FIG. 4 is a perspective view to show the cable adjustment device of the present invention connected with a bicycle rear derailleur system;

FIG. 5 is an exploded view to show the cable adjustment device of the present invention;

FIG. 6 is a cross sectional view to show the cable adjustment device of the present invention;

FIG. 7 shows that the adjustment bolt of the cable adjustment device of the present invention is pivoted in one direction;

FIG. 8 shows that the adjustment bolt of the cable adjustment device of the present invention is pivoted in another direction;

FIG. 9 shows a second embodiment of the connection between the pivotal member and the interior space of the cable adjustment device of the present invention, and

FIG. 10 shows a third embodiment of the connection between the pivotal member and the interior space of the cable adjustment device of the present invention.

### DETAILED DESCRIPTION OF THE PREFERRED EMBODIMENT

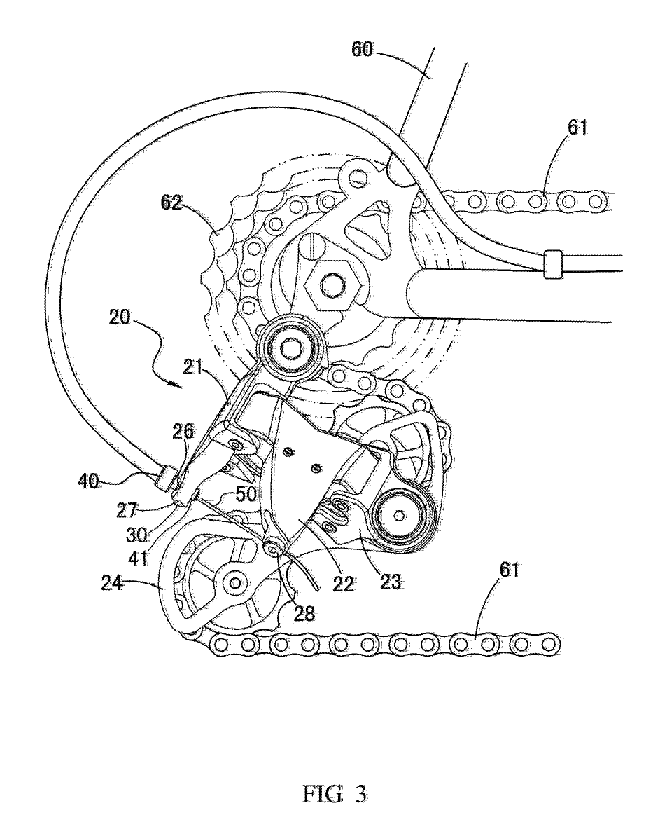

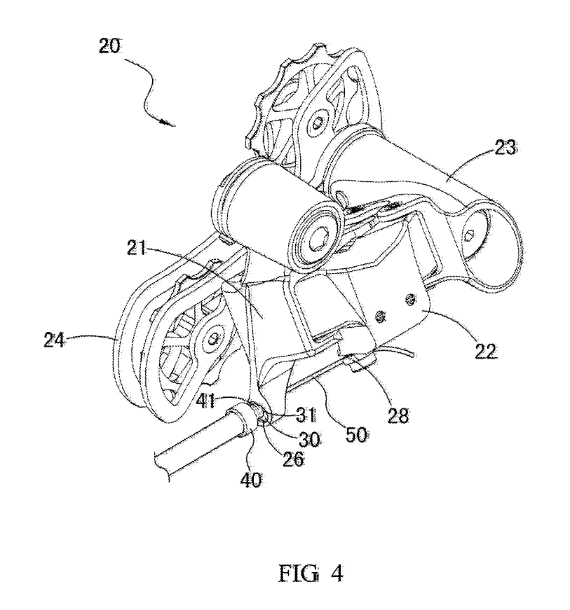

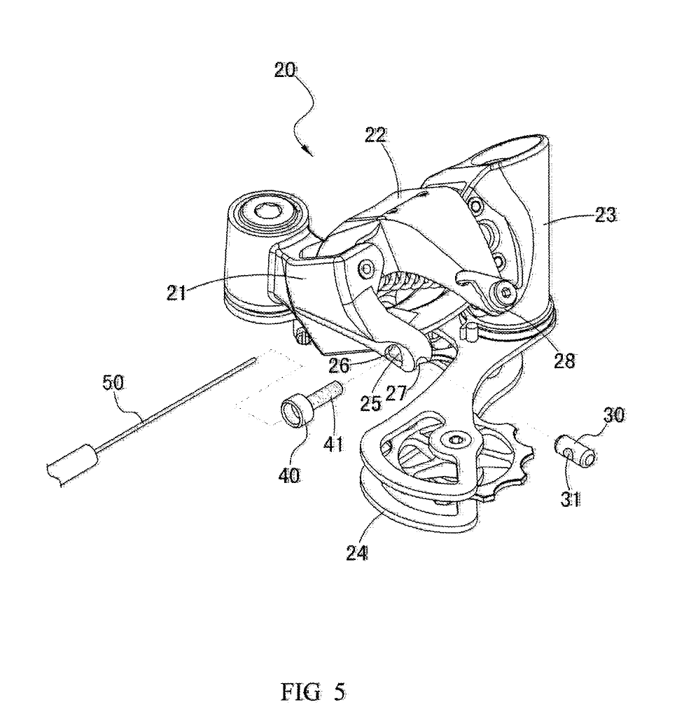

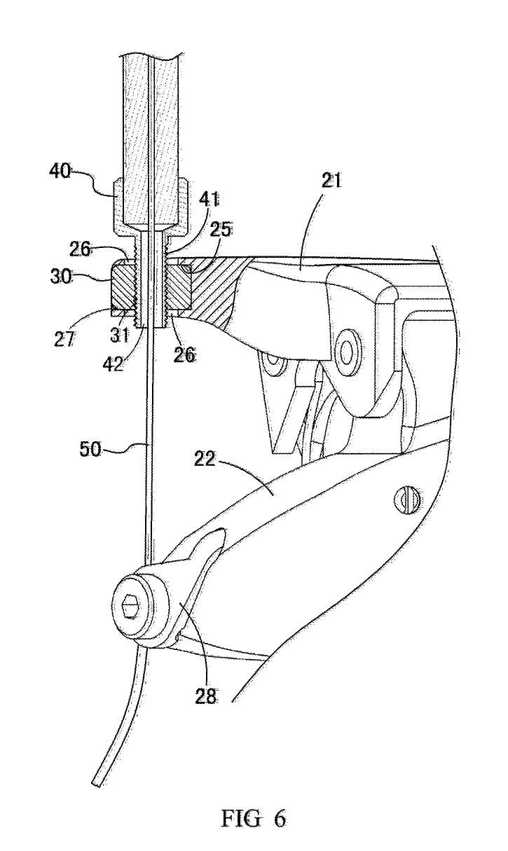

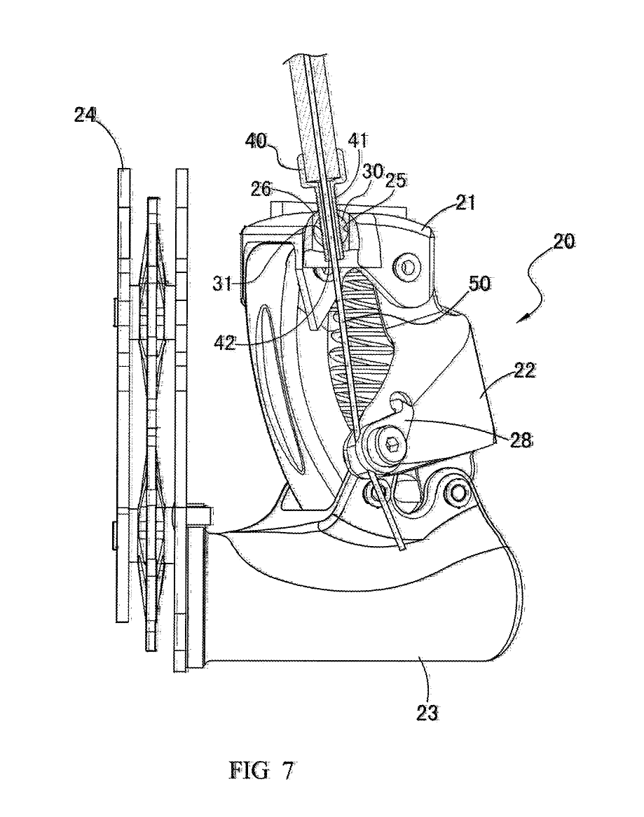

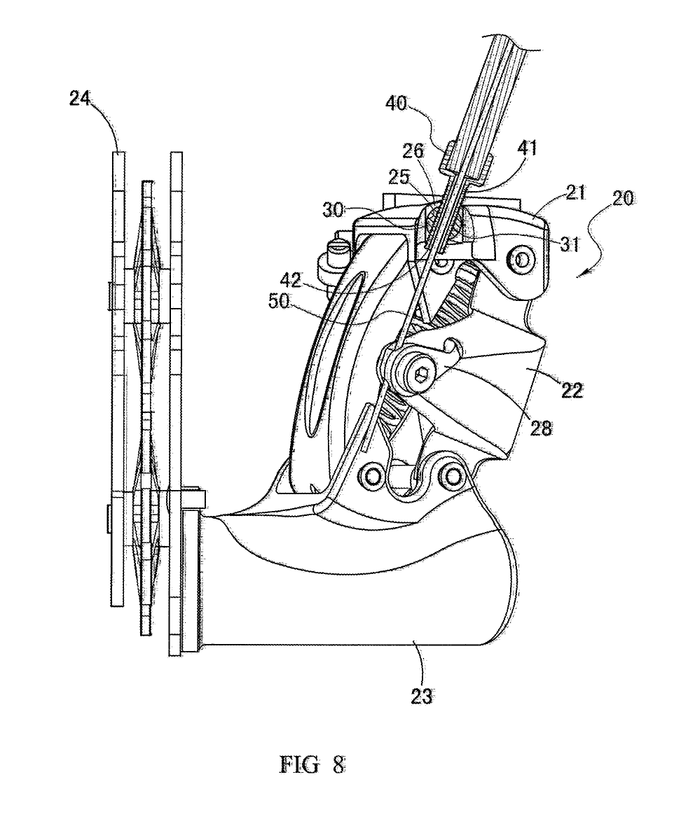

Referring to FIGS. 3 to 8, the cable adjustment device of the present invention comprises a rear derailleur system 20, a pivotal member 30, an adjustment bolt 40 and a cable 50.

The rear derailleur system 20 includes a stationary member 21, a link 22, a movable member 23 and a guide member 24. The stationary member 21 is connected to a bicycle seat stay 60 and has an interior space 25 defined therein. In this embodiment, the interior space 25 has a cylindrical inner wall. An elongate passage 26 is defined through the stationary member 21 and communicates with the interior space 25. The stationary member 21 includes a side hole 27 which communicates with the interior space 25. Two ends of the link 22 are connected to the stationary member 21 and the movable member 23 respectively. The movable member 23 is movable relative to the stationary member 21 in lateral direction. The link 22 has a clamping member 28 and the guide member 24 is connected to a side of the movable member 23. The chain 61 is engaged with the guide member 24 so that when the movable member 23 is pivoted an angle, the guide member 24 is moved in lateral direction and the chain 61 is shifted between the sprockets 62 of the rear derailleur system.

The pivotal member 30 is pivotably received in the interior space 25. In this embodiment, the pivotal member 30 is a cylindrical piece which is pivotably engaged with the cylindrical inner wall and can pivot about its axial axis. The pivotal member 30 is inserted into the interior space 25 via the side hole 27. The length of the pivotal member 30 is longer than the inner diameter of the passage 26, so that the pivotal member 30 cannot be separated from the passage 26. A threaded hole 31 is defined radially through the pivotal member 30.

The adjustment bolt 40 includes a threaded section 41 which extends through the passage 26 and is connected to the threaded hole 31. An outer diameter of the threaded section 41 is smaller than an inner diameter of the passage 26, and a through hole 42 defined axially through the adjustment bolt 40, and

The cable 50 has an end extending through the through hole 42 and is fixed to the clamping member 28.

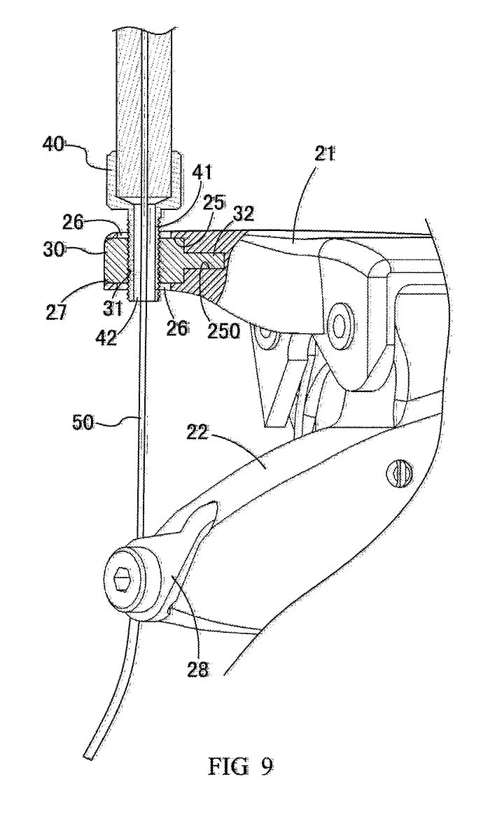

Referring to FIG. 9 which shows the second embodiment of the present invention and includes the same arrangement except for that a recess 250 is defined in an inner end of the interior space 25 and the pivotal member 30 includes a protrusion 32 extending from an end thereof, the protrusion 32 is rotatably engaged with the recess 250. The engagement of the protrusion 32 and the recess 250 enhance the stability of the rotation of the pivotal member 30.

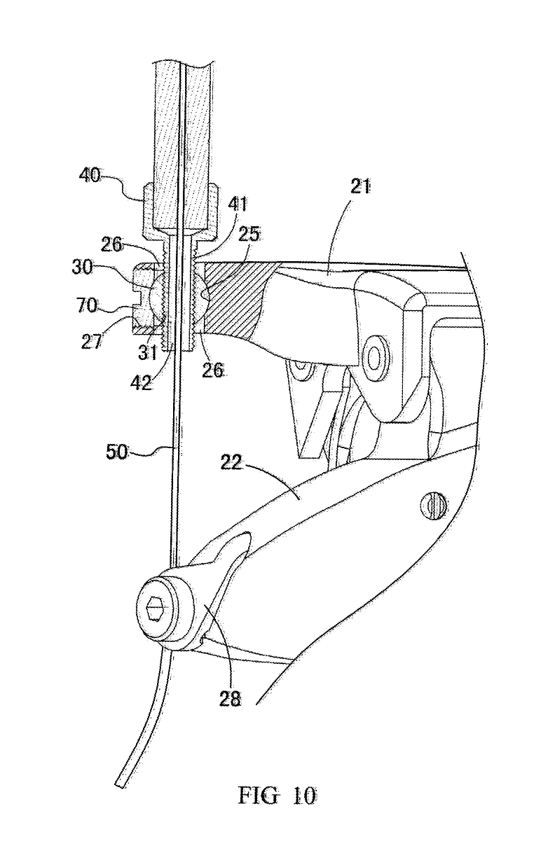

FIG. 10 shows the third embodiment of the present invention and includes the same arrangement except for that a plug 70 is engaged with the side hole 27 and restricts the pivotal member 30 within the interior space 25. The interior space 25 has a spherical inner wall and the pivotal member 30 is a spherical piece which is pivotably engaged with the spherical inner wall.

When the cable 50 is pulled to change the chain 61 between the sprockets 62, the adjustment bolt 40 is pivoted along with the pivotal action of the pivotal member 30, so that the cable 50 is not bent and kept to be straight between the adjustment bolt 40 and the clamping member 28. The specific arrangement allows the cable to respond the operation of the rear derailleur system quickly and the friction of the cable 50 can be minimized.

While we have shown and described the embodiment in accordance with the present invention, it should be clear to those skilled in the art that further embodiments may be made without departing from the scope of the present invention.

What is claimed is:

1. A cable adjustment device comprising:
a rear derailleur system including a stationary member, a link, a movable member and a guide member, the stationary member connected to a bicycle seat stay and having an interior space defined therein, a passage defined through the stationary member and communicating with the interior space, two ends of the link connected to the stationary member and the movable member respectively, the movable member being movable relative to the stationary member, the link having a clamping member and the guide member connected to a side of the movable member;
a pivotal member pivotably received in the interior space and being not capable of separating from the passage, a threaded hole defined radially through the pivotal member;
an adjustment bolt having a threaded section which extends through the passage and is connected to the threaded hole, an outer diameter of the threaded section being smaller than an inner diameter of the passage, a through hole defined axially through the adjustment bolt, and
a cable having an end extending through the through hole and being fixed to the clamping member.

2. The device as claimed in claim 1, wherein includes the stationary member includes a side hole which communicates with the interior space, the pivotal member is inserted into the interior space via the side hole.

3. The device as claimed in claim 2, wherein the interior space has a cylindrical inner wall and the pivotal member is a cylindrical piece which is pivotably engaged with the cylindrical inner wall.

4. The device as claimed in claim 3, wherein a recess is defined in an inner end of the interior space and the pivotal member includes a protrusion extending from an end thereof, the protrusion is rotatably engaged with the recess.

5. The device as claimed in claim 3, wherein the passage is an elongate passage and the threaded section is movable in the passage.

6. The device as claimed in claim 2, wherein the interior space has a spherical inner wall and the pivotal member is a spherical piece which is pivotably engaged with the spherical inner wall.

7. The device as claimed in claim 6, wherein a plug is engaged with the side hole and restricts the pivotal member within the interior space.
